(19) United States
(12) Patent Application Publication
(10) Pub. No.: US 2025/0187253 A1
(43) Pub. Date: Jun. 12, 2025

(54) MANUFACTURING METHOD OF AUTOMOTIVE FLOOR MAT

(71) Applicant: JIANGXI YAOMEI AUTO PARTS CO., LTD., Shangrao City (CN)

(72) Inventor: Wen ZHU, Ruian City (CN)

(73) Assignee: JIANGXI YAOMEI AUTO PARTS CO., LTD., Shangrao City, Jiangxi Province (CN)

(21) Appl. No.: 19/054,749

(22) Filed: Feb. 14, 2025

(51) Int. Cl. B29C 51/26; B29C 51/10; B29C 51/42; B29K 21/00; B29L 31/30

(52) U.S. Cl. CPC B29C 51/266; B29C 51/10; B29C 51/424; B29C 2793/009; B29K 2021/003; B29L 2031/3017

(57) ABSTRACT

A manufacturing method of an automotive floor mat includes: providing a thermoplastic sheet, and heating and softening the thermoplastic sheet; using a vacuum suction device to suck the softened thermoplastic sheet to cause a lower surface of the softened thermoplastic sheet to tightly abut against a mold; cooling and shaping the thermoplastic sheet; and punching the formed automotive floor mat from the sheet. A plurality of anti-slip convex nails are arranged on an upper surface of the thermoplastic sheet. A plurality of grooves and/or patterns are arranged on an outer surface of the mold.

### TECHNICAL FIELD

The present invention relates to the technical field of automobile accessories, and in particular, to a manufacturing method of an automotive floor mat.

### BACKGROUND OF THE INVENTION

Automobiles are commonly used means of transportation in daily life. To improve the comfort level, the aesthetics, and the heat retention property in winter, automotive floor mats are usually laid below automobile seats. As an automobile interior trim, the automotive floor mat can effectively keep an environment inside an automobile clean, protect the original floor mat, improve the comfort level, achieve sound insulation and shock absorption, and further beautify the appearance, which is widely favored.

At present, a production process of an automotive floor mat on the market mainly includes two parts. In one part, the automotive floor mats are manufactured using an injection molding technology, but the costs of molds used to manufacture the automotive floor mat using the injection molding technology is high, which are about five times that of a vacuum forming mold. Some automotive floor mats are manufactured using a vacuum forming technology. In the vacuum forming technology, a softened thermoplastic plate is adsorbed onto a male mold through vacuum adsorption. A lower surface of the thermoplastic material tightly abuts against the mold. After cooling and demolding, an automotive floor mat is formed. Since a lower surface of the automotive floor mat abuts against the mold during the molding, it is difficult to arrange anti-slip convex nails on the lower surface of the automotive floor mat. Even if anti-slip convex nails are arranged on the thermoplastic sheet, the anti-slip convex nails will deform during the molding and affect the molding effect of the automotive floor mat. The lack of the anti-slip convex nails can cause the automotive floor mat to slide under a force during use, and in severe cases, the automotive floor mat may get stuck on a gear lever, posing a risk to driving of a user. Meanwhile, since the thermoplastic sheet is in the softened state during the molding, the thermoplastic sheet may deform. As a result, unevenness and patterns on an upper surface of the automotive floor mat are not obvious, which affects the appearance of the automotive floor mat product. In addition, the friction between the upper surface of the automotive floor mat and shoe soles of a user is small, making it easy to slip. Moreover, the existing production molds for the automotive floor mat are fixed, and molds need to be replaced to produce automotive floor mats with different pattern designs, so that the costs are high.

Therefore, the present invention provides a manufacturing method of an automotive floor mat, which can effectively solve the above problems. By using the manufacturing method for the automotive floor mat of the present invention to manufacture the automotive floor mat, the anti-slip convex nails on the lower surface of the thermoplastic sheet are not affected during vacuum forming. These anti-slip convex nails can effectively pierce a felt of the automotive floor mat to firmly fix the floor mat. Meanwhile, forming three-dimensional protrusions and obvious anti-slip patterns on a surface of the automotive floor mat not only beautifies the appearance of the product, but also increases the friction between the floor mat and shoe soles, which provides a more reliable safety guarantee for daily driving. In addition, the vacuum forming mold is optimized. By the arrangement of a replaceable bottom plate forming portion, the bottom plate forming portion can be easily replaced during the production of the automotive floor mat, thereby changing the protrusions and patterns on the surface of the formed automotive floor mat, reducing the number of times of mold opening, effectively reducing the costs of the mold, and improving the production efficiency.

### SUMMARY OF THE INVENTION

To overcome the shortcomings of the prior art, the present invention provides a manufacturing method of an automotive floor mat, which has high production efficiency and low costs. Anti-slip convex nails at a bottom of a produced automotive floor mat can effectively fix the automotive floor mat, and protrusions and patterns on an upper surface of the produced automotive floor mat are outstanding.

The technical solution adopted by the present invention to solve the technical problem is as follows.

A manufacturing method of an automotive floor mat includes: providing a thermoplastic sheet, and heating and softening the thermoplastic sheet; using a vacuum suction device to suck the softened thermoplastic sheet to cause a lower surface of the softened thermoplastic sheet to tightly abut against a mold; cooling and shaping the thermoplastic sheet; and punching the formed automotive floor mat from the sheet. A plurality of anti-slip convex nails are arranged on an upper surface of the thermoplastic sheet. A plurality of grooves and/or patterns are arranged on an outer surface of the mold.

As an improvement of the present invention, a material of the thermoplastic sheet is thermoplastic vulcanizate (TPV).

As an improvement of the present invention, a heating temperature at which the thermoplastic vulcanizate is heated and softened is 210° C. to 248° C.

As an improvement of the present invention, a vacuum pressure at which the vacuum suction device is used to suck the softened thermoplastic sheet is −0.8 Mpa to −1.2 Mpa.

As an improvement of the present invention, a cooling mode for cooling and shaping the thermoplastic sheet is air cooling.

As an improvement of the present invention, cooling time for cooling and shaping the thermoplastic sheet is 20 seconds to 50 seconds.

As an improvement of the present invention, after the step of heating and softening the thermoplastic sheet, and before using a vacuum suction device to suck the softened thermoplastic sheet, the method further includes: moving the softened thermoplastic sheet to a position above the mold and covering a surface of the mold with the softened thermoplastic sheet.

As an improvement of the present invention, time for moving the softened thermoplastic sheet to a position above the mold, to cover a surface of the mold is about 20 seconds to 30 seconds.

As an improvement of the present invention, the mold always abuts against the thermoplastic sheet during cooling and shaping of the thermoplastic sheet.

As an improvement of the present invention, after the step of punching the formed automotive floor mat from the sheet, the method further includes: grinding and polishing edges of the automotive floor mat.

As an improvement of the present invention, the mold is a female mold.

As an improvement of the present invention, each anti-slip convex nail has a height of 2 to 4 mm and a diameter of 3 to 5 mm, and a distance between two adjacent anti-slip convex nails is 20 to 30 mm.

As an improvement of the present invention, each anti-slip convex nail is cylindrical, which has the height of 3 mm and the diameter of 4 mm, and the distance between two adjacent anti-slip convex nails is 25 mm.

As an improvement of the present invention, the mold includes a bottom plate forming portion and a side skirt forming portion, and the side skirt forming portion is connected to an edge of the bottom plate forming portion.

As an improvement of the present invention, forming grooves are provided in a surface of the side skirt forming portion and/or a surface of the bottom plate forming portion, and forming patterns are provided in at least some of the forming grooves.

As an improvement of the present invention, several protrusions are provided on a surface of the side skirt forming portion and/or a surface of the bottom plate forming portion, and adjacent protrusions are enclosed to form each forming groove.

As an improvement of the present invention, in the step of heating and softening the thermoplastic sheet, the thermoplastic sheet is heated using hot air, and heating time is about 30 seconds to 60 seconds.

As an improvement of the present invention, the mold further includes a base portion; an edge of the base portion extends upwards to form the side skirt forming portion; an inner side edge of the side skirt forming portion is enclosed to form a mounting slot; and the bottom plate forming portion is detachably inserted As an improvement of the present invention, the mold further includes a driving device; the driving device is arranged at the base portion; a driving end of the driving device is inserted into the mounting slot; and the driving device drives the bottom plate forming portion to move in a vertical direction of the mounting slot.

As an improvement of the present invention, before the step of punching the formed automotive floor mat from the sheet the method further includes: turning on the driving device, the driving device drives the sheet to move in a direction away from the base portion, to separate the sheet from the side skirt forming portion and the base portion.

Beneficial effects: during the production of the automotive floor mat, the thermoplastic sheet is heated to be softened; the vacuum suction device is used to suck the softened thermoplastic sheet, to cause the lower surface of the thermoplastic sheet tightly abut against the mold; and the protrusions and the patterns are formed on the lower surface of the thermoplastic sheet, and the anti-slip convex nails arranged on the upper surface of the thermoplastic sheet are not affected. The thermoplastic sheet is cooled and shaped, and the formed automotive floor mat is punched from the sheet to form the automotive floor mat. A lower surface of the automotive floor mat is in contact with an automobile floor, and the lower surface of the automotive floor mat corresponds to the upper surface of the thermoplastic sheet. The anti-slip convex nails distributed on the lower surface of the automotive floor mat can effectively pierce into a floor below a driver seat and felts on peripheral side walls of the floor, to firmly fix the automotive floor mat. The upper surface of the automotive floor mat corresponds to the lower surface of the thermoplastic sheet that tightly abuts against a surface of the mold. The protrusions and patterns formed on the upper surface of the automotive floor mat are outstanding, and the automotive floor mat product has a beautiful appearance and a good anti-slip effect.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a flowchart of a manufacturing method of the present invention;

FIG. 2 is a schematic diagram of production before vacuum forming shaping according to the present invention;

FIG. 3 is a schematic diagram of production during vacuum forming shaping according to the present invention;

FIG. 4 is a schematic diagram of a demolding state after vacuum forming shaping according to the present invention; and

FIG. 5 is a schematic exploded view of a mold according to the present invention.

### DETAILED DESCRIPTION OF THE INVENTION

To make the aforementioned objectives, features, and advantages of the present invention more comprehensible, specific implementations of the present invention are described in detail below in conjunction with the accompanying drawings. In the following description, numerous specific details are set forth to provide a thorough understanding of the present invention. The present invention may, however, be embodied in many forms different from that described here. A person skilled in the art can make similar improvements without departing from the connotation of the present invention. Therefore, the present invention is not limited by the specific embodiments disclosed below.

In the description of the present invention, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present invention and simplifying the description, Rather than indicating or implying that the indicated device or element must have a particular orientation, be constructed and operated in a particular orientation, therefore, not to be construed as limiting the present invention.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present invention, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present invention can be understood based on specific circumstances.

In the present invention, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

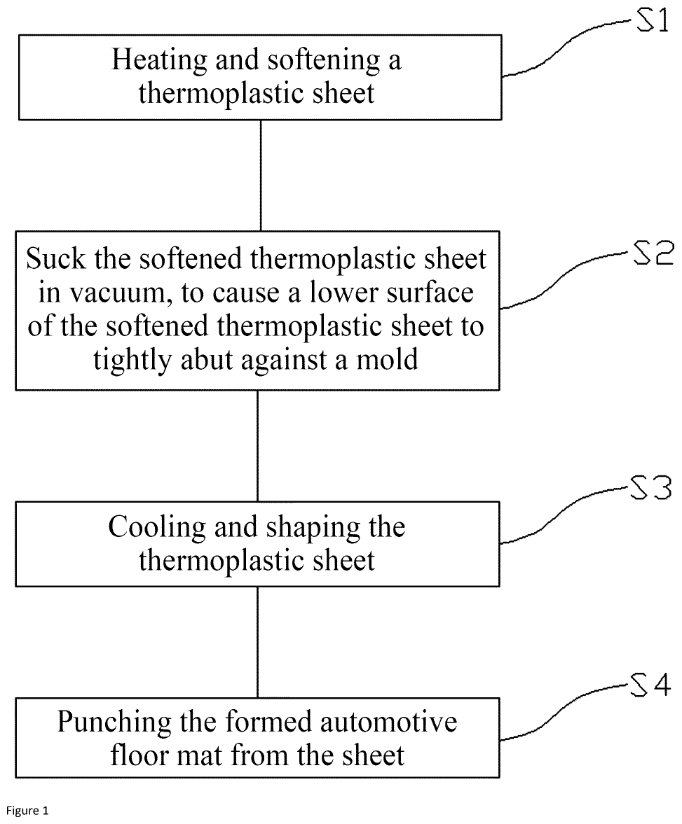

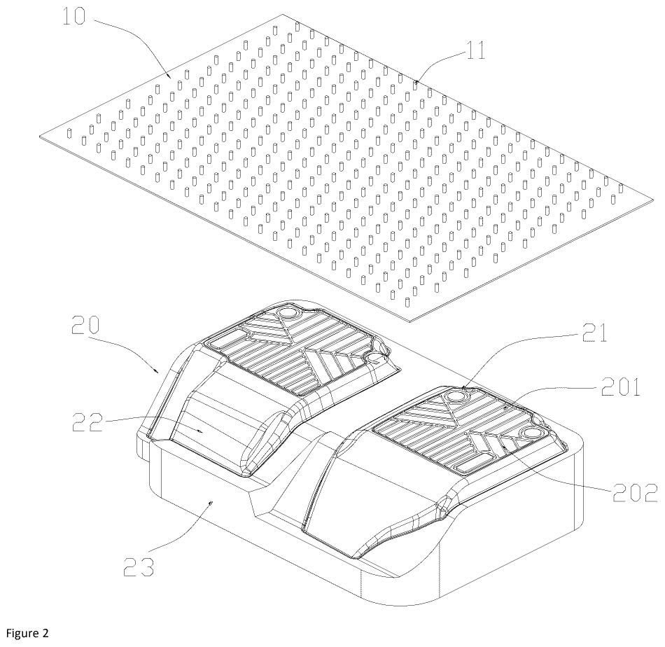

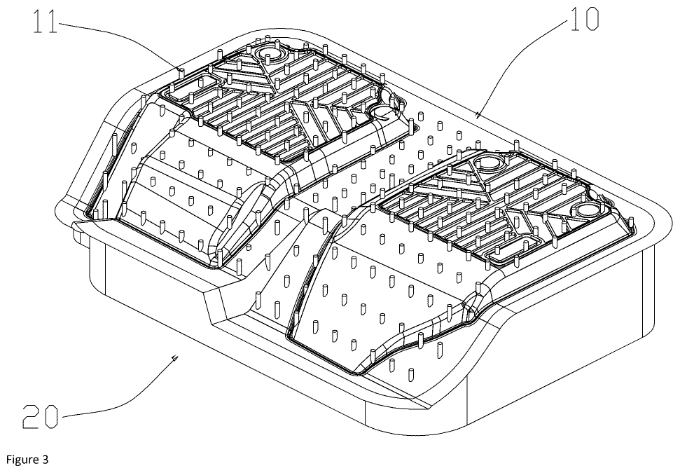

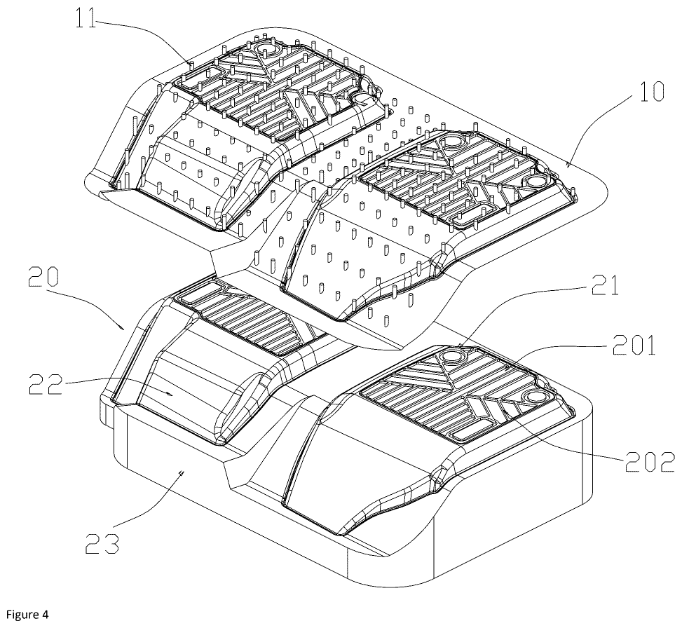

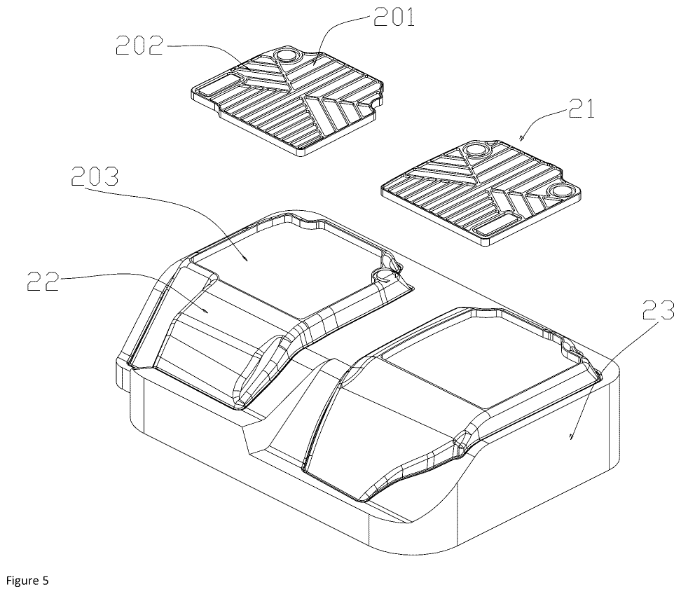

Referring to FIG. 1 to FIG. 5, a manufacturing method of an automotive floor mat includes:
S1, providing a thermoplastic sheet 10, and heating and softening the thermoplastic sheet 10, anti-slip convex nails 11 are arranged on an upper surface of the thermoplastic sheet 10;
S2, using a vacuum suction device to suck the softened thermoplastic sheet 10, to cause a lower surface of the softened thermoplastic sheet 10 to tightly abut against a mold 20, grooves and/or patterns are arranged on an outer surface of the mold 20;
S3, cooling and shaping the thermoplastic sheet 10; and
S4, punching the formed automotive floor mat from the sheet.

During the production of the automotive floor mat, the thermoplastic sheet 10 is heated to be softened; the vacuum suction device is used to suck the softened thermoplastic sheet 10, to cause the lower surface of the thermoplastic sheet 10 tightly abut against the mold 20; and the protrusions and the patterns are formed on the lower surface of the thermoplastic sheet 10, and the anti-slip convex nails 11 arranged on the upper surface of the thermoplastic sheet 10 are not affected. The thermoplastic sheet 10 is cooled and shaped, and the formed automotive floor mat is punched from the sheet to form the automotive floor mat. A lower surface of the automotive floor mat is in contact with an automobile floor, and the lower surface of the automotive floor mat corresponds to the upper surface of the thermoplastic sheet 10. The anti-slip convex nails 11 distributed on the lower surface of the automotive floor mat can effectively pierce into a floor below a driver seat and felts on peripheral side walls of the floor, to firmly fix the automotive floor mat. The upper surface of the automotive floor mat corresponds to the lower surface of the thermoplastic sheet 10 that tightly abuts against a surface of the mold 20. The protrusions and patterns formed on the upper surface of the automotive floor mat are outstanding, and the automotive floor mat product has a beautiful appearance and a good anti-slip effect.

In this embodiment, a material of the thermoplastic sheet 10 is TPV. The automotive floor mat made from the TPV sheet has good elasticity, toughness, tear resistance, and fatigue resistance, which can effectively ensure the quality of automotive floor mat, prolong the service life of the product. The automotive floor mat has high chemical stability and good chemical corrosion resistance and weather resistance, which can further prolong the service life of the product and enhance the user experience. Moreover, in a production process, the processing cycle of the TPV is short, and the speed of heating for softening and cooling for shaping during the processing is relatively high, thereby greatly improving the production efficiency. Furthermore, the material is recyclable, so that it is energy-saving and environmentally friendly, and reduces the production costs.

In this embodiment, a heating temperature at which the thermoplastic vulcanizate is heated and softened is 210° C. to 248° C. A softening temperature of the thermoplastic vulcanizate is between 150° C. and 170° C. Setting the heating temperature between 210° C. and 248° C. can quickly and uniformly heat and soften the thermoplastic vulcanizate, causing the thermoplastic vulcanizate to quickly reach the softening point and improve the processing efficiency. Moreover, the heating temperature will not be too high, to avoid a decrease in the mechanical properties, loss of the elasticity, a color change, and the like of the material due to an excessive heating temperature, and prevent material decomposition and the production of harmful gas.

In this embodiment, a vacuum pressure at which the vacuum suction device is used to suck the softened thermoplastic sheet 10 is −0.8 Mpa to −1.2 Mpa. A vacuum pump is used to suck the softened thermoplastic sheet 10, at the vacuum pressure set to be −0.8 Mpa to −1.2 Mpa, so that the softened thermoplastic sheet 10 can be quickly and stably adsorbed onto the surface of the mold 20, and the lower surface of the softened thermoplastic sheet 10 completely abuts against the upper surface of the mold 20, to quickly form the product. In addition, the vacuum pressure ranging from −0.8 Mpa to −1.2 Mpa can further prevent problems such as non-uniform product thickness caused by an excessive vacuum pressure.

In this embodiment, a cooling mode for cooling and shaping the thermoplastic sheet 10 is air cooling. The air cooling mode can slowly and stably reduce the temperature of the thermoplastic sheet 10, to prevent deformation caused by a rapid temperature drop, ensure the shape of the product, further facilitate subsequent demolding, and improve the production efficiency. Moreover, slow cooling has less thermal impact on the mold 20, thus prolonging the service life of the mold 20. Furthermore, equipment required in the air cooling is simple and has low costs.

In this embodiment, cooling time for cooling and shaping the thermoplastic sheet 10 is 20 seconds to 50 seconds. It almost takes 20 seconds to 50 seconds to achieve cooling and shaping of the thermoplastic sheet 10 in the air cooling mode, so that the shape of the thermoplastic sheet 10 is fixed, which facilitates subsequent demolding, ensures the shape of the product, prevents deformation of the product, and improves the quality of the product. Meanwhile, a user can also select to prolong or shorten the cooling time based on a thickness of the thermoplastic sheet 10, to improve the production efficiency while ensuring the cooling and shaping effect.

In this embodiment, after the step of heating and softening the thermoplastic sheet 10, and before using a vacuum suction device to suck the softened thermoplastic sheet 10, the method further includes: moving the softened thermoplastic sheet 10 to a position above the mold 20 and covering a surface of the mold 20 with the softened thermoplastic sheet 10. Moving the softened thermoplastic sheet 10 to the position above the mold 20 can separate the thermoplastic sheet 10 from a heating area, and cover the surface of the mold 20 with the softened thermoplastic sheet 10, thereby facilitating subsequent vacuum forming, cooling, and shaping, and improving the working efficiency of vacuum forming, cooling, and shaping. Moving the softened thermoplastic sheet 10 away from the heating area can move the subsequent thermoplastic sheet 10 to the heating area for heating, thereby improving the production efficiency of the product.

In this embodiment, time for moving the softened thermoplastic sheet 10 to a position above the mold 20 and covering a surface of the mold 20 with the softened thermoplastic sheet 10 is about 20 seconds to 30 seconds. After the thermoplastic sheet 10 is softened, the thermoplastic sheet 10 needs to be quickly moved to the mold 20 for vacuum forming and shaping to avoid the impact on the vacuum forming effect due to the prolonged cooling and shaping of the softened thermoplastic sheet 10. Controlling the time for moving the softened thermoplastic sheet 10 to be 20 seconds to 30 seconds can ensure that the thermoplastic sheet 10 moved to the mold 20 remains in the softened state, thereby ensuring the effect of vacuum forming and shaping.

In this embodiment, the mold 20 always abuts against the thermoplastic sheet 10 during cooling and shaping of the thermoplastic sheet 10. Keeping the mold 20 always abutting against the thermoplastic sheet 10 and cooling the mold 20 together with the thermoplastic sheet 10 can cool and shape the softened thermoplastic sheet 10, so that the thermoplastic sheet 10 during cooling cannot deform, thereby ensuring the stability of the shape of the product, reducing the temperature of the mold 20, preventing the mold 20 from remaining in a high-temperature state, prolonging the service life of the mold 20, and accelerating the cooling and shaping of the softened thermoplastic sheet during next vacuum forming.

In this embodiment, after the step of punching the formed automotive floor mat from the sheet, the method further includes: grinding and polishing edges of the automotive floor mat. After the formed automotive floor mat is punched from the sheet, the edges of the automotive floor mat are ground, which can remove burrs generated in the punching process. The edges of the automotive floor mat are ground to be smooth, which beautifies the appearance of the product, and effectively prevents a user from being scratched by the edges of the floor mat, achieving a better user experience.

In this embodiment, the mold 20 is a female mold. The mold 20 used is the female mold. During the production, the upper surface of the automotive floor mat is opposite to recesses, protrusions, and patterns on the surface of the mold 20, so that the patterns on the upper surface of the automotive floor mat are clearer, edges of raised portions are straighter, and the appearance of the product is more beautiful.

In this embodiment, each anti-slip convex nail 11 has a height of 2 to 4 mm and a diameter of 3 to 5 mm, and a distance between two adjacent anti-slip convex nails 11 is 20 to 30 mm. Like a claw, the plurality of anti-slip convex nails 11 pierce into the floor below the driver seat and the felts on the peripheral side walls of the floor, which effectively prevents the feet of a driver from pushing the automotive floor mat below the driver seat forwards in a process that the feet move forwards, thereby avoiding the automotive floor mat from getting stuck on a brake pedal and a steering wheel transmission shaft, eliminating the potential safety hazard, improving the user experience, the preventing a user from slipping. By setting the height of each anti-slip convex nail 11 to be 2 to 4 mm and the diameter to be 3 to 5 mm, it is possible to allow the anti-slip convex nails 11 to be inserted into a carpet or a felt. The distance between the adjacent anti-slip convex nails 11 is 20 to 30 mm, so that the anti-slip convex nails 11 can be uniformly distributed on the lower surface of the automotive floor mat, and all positions of the automotive floor mat can be uniformly stressed. The product has a more stable structure and a better anti-slip effect.

In this embodiment, each anti-slip convex nail 11 is cylindrical, which has the height of 3 mm and the diameter of 4 mm, and the distance between two adjacent anti-slip convex nails 11 is 25 mm.

In this embodiment, the mold 20 includes a bottom plate forming portion 21 and a side skirt forming portion 22, and the side skirt forming portion 22 is connected to an edge of the bottom plate forming portion 21. During the production, the softened thermoplastic sheet 10 is sucked in vacuum. The thermoplastic sheet 10 abuts against the bottom plate forming portion 21 and the side skirt forming portion 22, so that shapes of corresponding contact portions of the bottom plate forming portion 21 and the side skirt forming portion 22 are matched. The thermoplastic sheet 10 is formed into an integrated automotive floor mat with a bottom plate and a side skirt.

In this embodiment, forming grooves 201 are provided in a surface of the side skirt forming portion 22 and/or a surface of the bottom plate forming portion 21, and forming patterns are provided in at least some of the forming grooves 201. The forming grooves 201 are provided in the surface of the side skirt forming portion 22 and/or the surface of the bottom plate forming portion 21. During vacuum forming and forming, the softened thermoplastic sheet 10 deforms and abuts against the surface of the side skirt forming portion 22 and/or the surface of the bottom plate forming portion 21, thus forming protrusions on the surface of the thermoplastic sheet 10. Shapes and sizes of the protrusions are matched with those of the forming grooves 201. Correspondingly, the forming patterns are further arranged in the forming grooves 201, which will form corresponding patterns on surfaces of the protrusions of the automotive floor mat, thereby beautifying the appearance of the product and improving the anti-slip ability of the product.

In this embodiment, several protrusions are provided on a surface of the side skirt forming portion 22 and/or a surface of the bottom plate forming portion 21, and adjacent protrusions are enclosed to form each forming groove 201. The protrusions on the surface of the side skirt forming portion 22 and/or on the surface the bottom plate forming portion 21 are strip-shaped, and the plurality of strip-shaped protrusions 202 are enclosed to form the forming grooves 201, making the structure of the product more stable. Furthermore, after the automotive floor mat is formed, the grooves are formed in positions, corresponding to the protrusions, on the upper surface of the automotive floor mat, so that the upper surface of the automotive floor mat is more convex and concave, with clearer protrusions and grooves, and the product is more beautiful.

In this embodiment, in the step of heating and softening the thermoplastic sheet 10, the thermoplastic sheet 10 is heated using hot air, and heating time is about 30 seconds to 60 seconds. Using the hot air for heating can efficiently heat the thermoplastic sheet 10, and all portions of the thermoplastic sheet 10 can be uniformly heated, thereby enhancing the vacuum forming and forming effect on the product. Preferably, a hot air outlet can face the lower surface of the thermoplastic sheet 10, so that the lower surface of the thermoplastic sheet 10 is heated earlier, which avoids premature softening and deformation of the anti-slip convex nails 11 on the upper surface of the thermoplastic sheet 10, so that the formed automotive floor mat has a more stable structure, and the fixing effect of the anti-slip convex nails 11 is more obvious, thereby improving the anti-slip ability of the product.

In this embodiment, the mold 20 further includes a base portion 23; an edge of the base portion 23 extends upwards to form the side skirt forming portion 22; an inner side edge of the side skirt forming portion 22 is enclosed to form a mounting slot 203; and the bottom plate forming portion 21 is detachably inserted into the mounting slot. The bottom plate forming portion 21 can be detachably inserted into the mounting slot, which can allow a user to replace bottom plate forming portions 21 with different protrusions and patterns, without manufacturing various different molds 20, thus reducing the costs of the product and improving the production efficiency.

In this embodiment, the mold 20 further includes a driving device; the driving device is arranged at the base portion 23; a driving end of the driving device is inserted into the mounting slot; and the driving device drives the bottom plate forming portion 21 to move in a vertical direction of the mounting slot.

In this embodiment, before the step of punching the formed automotive floor mat from the sheet the method further includes: turning on the driving device, the driving device drives the sheet to move in a direction away from the base portion 23, to separate the sheet from the side skirt forming portion 22 and the base portion 23. During the vacuum forming and forming, the driving device drives the bottom plate forming portion 21 to move downwards and inserts it approximately completely into the mounting slot. In this case, an edge of the bottom plate forming portion 21 is roughly flush with an edge of the side skirt forming portion 22. In this case, vacuum forming is performed, which can quickly cause the softened thermoplastic sheet 10 to abut against the mold 20, thereby forming the softened thermoplastic sheet 10. During cooling and demolding, the driving device is used to drive the bottom plate to move upwards, so that an edge of the formed thermoplastic sheet 10 are separated from the base portion 23 and the side skirt forming portion 22, and then a middle portion of the formed thermoplastic sheet 10 is separated from the bottom plate forming portion 21, which facilitates demolding and improves the demolding efficiency.

1. A manufacturing method of an automotive floor mat, comprising:
providing a thermoplastic sheet, and heating and softening the thermoplastic sheet, wherein anti-slip convex nails are arranged on an upper surface of the thermoplastic sheet;
using a vacuum suction device to suck the softened thermoplastic sheet, to cause a lower surface of the softened thermoplastic sheet to tightly abut against a mold, wherein grooves and/or patterns are arranged on an outer surface of the mold;
cooling and shaping the thermoplastic sheet; and
punching the formed automotive floor mat from the sheet.

2. The manufacturing method of the automotive floor mat according to claim 1, wherein a material of the thermoplastic sheet is thermoplastic vulcanizate (TPV).

3. The manufacturing method of the automotive floor mat according to claim 2, wherein a heating temperature at which the thermoplastic vulcanizate is heated and softened is 210° C. to 248° C.

4. The manufacturing method of the automotive floor mat according to claim 1, wherein a vacuum pressure at which the vacuum suction device is used to suck the softened thermoplastic sheet is −0.8 Mpa to −1.2 Mpa.

5. The manufacturing method of the automotive floor mat according to claim 1, wherein a cooling mode for cooling and shaping the thermoplastic sheet is air cooling.

6. The manufacturing method of the automotive floor mat according to claim 5, wherein cooling time for cooling and shaping the thermoplastic sheet is 20 seconds to 50 seconds.

7. The manufacturing method of the automotive floor mat according to claim 1, wherein after the step of heating and softening the thermoplastic sheet, and before using a vacuum suction device to suck the softened thermoplastic sheet, the method further comprises: moving the softened thermoplastic sheet to a position above the mold and covering a surface of the mold with the softened thermoplastic sheet.

8. The manufacturing method of the automotive floor mat according to claim 7, wherein time for moving the softened thermoplastic sheet to a position above the mold, to cover a surface of the mold is about 20 seconds to 30 seconds.

9. The manufacturing method of the automotive floor mat according to claim 1, wherein the mold always abuts against the thermoplastic sheet during cooling and shaping of the thermoplastic sheet.

10. The manufacturing method of the automotive floor mat according to claim 1, wherein after the step of punching the formed automotive floor mat from the sheet, the method further comprises: grinding and polishing edges of the automotive floor mat.

11. The manufacturing method of the automotive floor mat according to claim 1, wherein the mold is a female mold.

12. The manufacturing method of the automotive floor mat according to claim 1, wherein each anti-slip convex nail has a height of 2 to 4 mm and a diameter of 3 to 5 mm, and a distance between two adjacent anti-slip convex nails is 20 to 30 mm.

13. The manufacturing method of the automotive floor mat according to claim 12, wherein each anti-slip convex nail is cylindrical, which has the height of 3 mm and the diameter of 4 mm, and the distance between two adjacent anti-slip convex nails is 25 mm.

14. The manufacturing method of the automotive floor mat according to claim 1, wherein the mold comprises a bottom plate forming portion and a side skirt forming portion, and the side skirt forming portion is connected to an edge of the bottom plate forming portion.

15. The manufacturing method of the automotive floor mat according to claim 14, wherein forming grooves are provided in a surface of the side skirt forming portion and/or a surface of the bottom plate forming portion, and forming patterns are provided in at least some of the forming grooves.

16. The manufacturing method of the automotive floor mat according to claim 14, wherein several protrusions are provided on a surface of the side skirt forming portion and/or a surface of the bottom plate forming portion, and adjacent protrusions are enclosed to form each forming groove.

17. The manufacturing method of the automotive floor mat according to claim 1, wherein in the step of heating and softening the thermoplastic sheet, the thermoplastic sheet is heated using hot air, and heating time is about 30 seconds to 60 seconds.

18. The manufacturing method of the automotive floor mat according to claim 14, wherein the mold further comprises a base portion; an edge of the base portion extends upwards to form the side skirt forming portion; an inner side edge of the side skirt forming portion is enclosed to form a mounting slot; and the bottom plate forming portion is detachably inserted into the mounting slot.

19. The manufacturing method of the automotive floor mat according to claim 18, wherein the mold further comprises a driving device; the driving device is arranged at the base portion; a driving end of the driving device is inserted into the mounting slot; and the driving device drives the bottom plate forming portion to move in a vertical direction of the mounting slot.

20. The manufacturing method of the automotive floor mat according to claim 19, wherein before the step of punching the formed automotive floor mat from the sheet the method further comprises: turning on the driving device, wherein the driving device drives the sheet to move in a direction away from the base portion, to separate the sheet from the side skirt forming portion and the base portion.
